(19) United States
(12) Patent Application Publication
(10) Pub. No.: US 2020/0113375 A1
(43) Pub. Date: Apr. 16, 2020

(54) COATING MATERIAL FOR A SELF-CLEANING COATING, AND METHOD FOR PRODUCING SAME

(71) Applicant: BSH Hausgeräte GmbH, Munich (DE)

(72) Inventors: Silke Bernhardt, Etzling (FR); Frank Jördens, Traunstein (DE); Frank Meyer, St. Ingbert (DE); Jürgen Salomon, Trostberg (DE); Gerhard Schmidmayer, Bad Endorf (DE)

(21) Appl. No.: 16/477,905

(22) PCT Filed: Jan. 10, 2018
(86) PCT No.: PCT/EP2018/050490

§ 371 Date: Jul. 15, 2019

(30) Foreign Application Priority Data
Jan. 16, 2017 (DE) 10 2017 200 565.3

(51) Int. Cl. A47J 36/02; C09D 1/00; F24C 15/00

(52) U.S. Cl. CPC A47J 36/025; F24C 15/005; C09D 1/00

(57) ABSTRACT

A coating material, suitable for a self-cleaning coating on a part on or in a cooking, frying, baking or grilling appliance for removing residual foodstuffs without mechanical intervention, includes porous particles and a binder which connects the porous particles. The binder has precipitated, inorganic particles which are particles produced via a precipitation reaction and subsequent grinding.

The present invention relates to a coating material for a self-cleaning coating on a part on or in a cooking, frying, baking or grilling appliance for removing residual foodstuffs without mechanical intervention, as well as to a method for producing a self-cleaning coating on a part on or in a cooking, frying, baking or grilling appliance, as well as to a part on or in a cooking, frying, baking or grilling appliance, comprising said coating.

In the prior art, some self-cleaning coatings on or in a cooking, frying, baking or grilling appliance are already known, by way of which the residual foodstuffs are removed without mechanical interventions.

In particular, DE 101 50 825 A1 shows a self-cleaning coating of this kind, which has porous particles and a particulate binder. In one form of embodiment of DE 101 50 825 A1, the binders are produced via a sol-gel process and have an average particle size of less than 100 nm. Alternatively, a binder based on glass or clay etc. is used, wherein the particles then have a diameter of 0.5 to 10 μm. These binders are produced by flame pyrolysis and/or by grinding.

Furthermore, a method is known from WO 03/027348 A2 for producing a porous ceramic layer, wherein a porous ceramic powder is mixed with an inorganic binder system, which contains at least one nanoscale powder as well as a solvent, to form a backfill. In this context, the nanoscale powder of the binder system preferably has an average particle size of below 100 nm. The nanoscale powders of WO 03/027348 A2 are produced by flame pyrolysis.

The coatings disclosed in the prior art, however, have insufficient binding properties and lead to looser, instable coatings, in particular at high operating temperatures and/or with longer usage. Furthermore, the production costs of conventional coatings are high and associated with a great amount of complexity due to the use of binder particles, which are generated via a sol-gel process or by flame pyrolysis.

Thus, the object of the present invention is to provide a coating material which is suitable for a self-cleaning coating on a part on or in a cooking, frying, baking or grilling appliance and allows residual foodstuffs to be removed without mechanical intervention, wherein the coating additionally has an improved bonding to the substrate. Furthermore, the object of the present invention lies in providing a method for producing a self-cleaning coating on a part or in a cooking, frying, baking or grilling appliance, which can be performed effectively and more cost-effectively than conventional methods.

This object is achieved by the coating material as claimed in claim 1. Preferred forms of embodiment of the coating material are described in the subclaims 2 to 6, which are also included in combination with one another according to the invention. The object is further achieved by the method as claimed in claim 7. Preferred forms of embodiment of the method are described in the claims 8 to 13, which are also included in combination with one another. The object is further achieved by a part on or in a cooking, frying, baking or grilling appliance as claimed in claim 14, as well as a cooking, frying, baking or grilling appliance as claimed in claim 15.

The coating material of the present invention is suitable for a self-cleaning coating on a part or in a cooking, frying, baking or grilling appliance for removing residual foodstuffs without mechanical intervention. The coating material has porous particles and a binder, wherein the binder has precipitated, inorganic particles.

The binder has the function of connecting the porous particles to one another and to the substrate and, nonetheless, containing the porous structure of the coating. By using precipitated, organic particles as binders, a coating material is successfully produced which has an improved bonding to the substrate, i.e. to the part on or in a cooking, frying, baking or grilling appliance, in particular compared to systems which have been produced by using particles which have been generated by a sol-gel process or flame pyrolysis.

It has unexpectedly been shown that by using particles of this type, which are simpler and more cost-effective to produce, it is possible to overcome the problems which occur with the systems from the prior art.

Precipitated, inorganic particles, preferably oxides, are particles which have been produced via a precipitation reaction, in which the reactants are initially present as dissolved in the solvent. By suitable induction of a chemical reaction, at least one product of the reaction is obtained, which is insoluble or poorly soluble in a solvent, and is precipitated from the solution by cooling down. The precipitated product is present in particulate form and can be used as the precipitated particles in accordance with the present invention.

In this context, the precipitated inorganic particles can be directly used as binder particles. In another form of embodiment, the precipitated, inorganic particles of the binder are particles which are produced via a precipitation reaction and subsequent grinding, preferably by a bead mill or pin mill. The use of precipitated, inorganic particles enables a significant reduction in the grinding duration compared to particles produced by flame pyrolysis, or particles which are produced via a sol-gel process. For this reason, the coating materials of the present invention are able to be produced in a more cost-effective manner. The particles may be present both as individual primary particles and in the form of aggregates, and used as binders.

The reason for the improved bonding properties of the binder particles according to the invention compared to the binder particles from the prior art is unknown and therefore surprising. However, precipitated particles, i.e. particles which have been produced via a precipitation reaction, show other properties compared to particles which have been produced via a sol-gel process, or particles which have been produced via flame pyrolysis. For example, precipitated particles, e.g. in forms of embodiment, possess a specific BET surface area of 75-1000, preferably 100-750, particularly preferably 200-500 m²/g. By contrast, particles produced by flame pyrolysis possess lower specific BET surface areas, such as 50 m²/g for example, at comparable particle sizes. This can be clarified by precipitated inorganic particles being porous, at least in forms of embodiment, while particles produced by flame pyrolysis are not porous, at least partially or at small particle sizes. In forms of embodiment, precipitated particles further possess a pH value of 6-10, preferably of 7-9. By contrast, the pH value of particles produced by flame pyrolysis is lower, e.g. in the range of 3-5. In the following table, the physical properties of two forms of embodiment of corresponding particles are summarized.

| | Precipitated | Titanium dioxide produced |
|---|---|---|
| | titanium oxide | by flame pyrolysis |
| | Hombikat 8602 | Aeroxide TiO₂ P25 |
| TiO₂ content [%] | >85 | >99.5 |
| Specific surface area [m²/g] | >250 | 50 +/− 15 |
| Loss on ignition [%] | <20 | <2.0 |
| Primary particle size [nm] | 5-10 | 21 |
| pH value | 7-8.5 | 3.5-4.5 |

With regard to the conventional binder particles of DE 101 50 825 A1, the inventors have further established that the binders used in the one form of embodiment on the basis of glass or clay etc., which have an average diameter of 0.5 to 10 μm, have a level of bonding which is yet more insufficient than that of the other form of embodiment of DE 101 50 825 A1, which uses binder particles which are produced via a sol-gel process and have an average particle size of less than 100 nm.

It could therefore be assumed that the average particle size of the binder particles generally has an influence on the bonding properties of the binder, namely on the lines of a reduction in the average particle size causing an improvement in the bonding. However, particles with smaller particle sizes, in particular of less than 100 nm, have the disadvantage that they are more difficult to produce and process.

The precipitated, organic particles of the binder of the present invention have the advantage that they are not subject to any restrictions with regard to the average particle size, in order to achieve an improved bonding compared with the particles from the prior art. It is therefore possible for particles with an average particle diameter of 100 nm or smaller to be used. It is also possible, however, for average particle sizes of greater than 100 nm to be used, preferably from 150 nm to 1,000 nm, more preferably 200 nm to 750 nm, particularly preferably from 250 nm to 500 nm. Even such particles according to the invention with an average particle diameter of >100 have an improved level of bonding in this context. At the same time, the use of particles with an average particle diameter of >100 nm has the advantage that the particles are able to be produced and processed in a simple manner.

Surprisingly, it has been shown that in the case of the binders according to the invention, the bonding properties of the coating are also positive with considerably greater particle diameters, i.e. the precipitated inorganic particles used in the binder have the advantage that outstanding bonding properties are able to be achieved, even with an average particle size of greater than 100 nm in particular.

The average particle size in accordance with the present invention relates to the D50 value of the particle diameter, which is measured by means of dynamic light scattering at two angles and NIBS optics (Non-Invasive Back Scatter). To this end, the Zetasizer Nano ZS device by the company Malvern Instruments can be used, for example. To calculate the particle size, it is assumed that the particles are spherical.

In forms of embodiment, the precipitated, inorganic particles of the binder are selected from the group comprising inorganic oxides, such as Al₂O₃, SiO₂, TiO₂, ZrO₂ or mixtures of these, preferably TiO₂. These compounds are easy and cost-effective to obtain via a precipitation reaction. They further have a high compatibility with the other components of the coating or with the substrate, which causes good bonding properties.

According to the invention, it is preferred if the binder is porous. The pores of the binder are preferably present with open porosity. It is thus ensured that the porous structure of the coating is retained and the self-cleaning property of the coating is not impaired. In forms of embodiment, however, a non-porous structure of the binder is sufficient.

In addition to the binder, the coating material in accordance with the present invention has porous particles, which are essentially responsible for the self-cleaning properties of the coating. In forms of embodiment, the porous particles in accordance with DE 101 50 825 A1 may be used for the porous particles of the present invention.

Preferably, the coating material has a porous structure consisting of the porous particles and the binder, wherein the porous particles have no solid or liquid second phase in their pores.

In particular, the porous particles possess an average particle size of 1 to 100 μm. Preferred sizes lie at 10 to 80 μm, 20 to 60 μm, as well as 30 to 50 μm. The porous particles preferably have a specific BET surface area of greater than 75 m²/g, preferably greater than 100 m²/g and particularly preferably greater than 200 m²/g.

The pores of the porous particles are either in a magnitude such that the impurities cannot penetrate them, according to the invention below 1 μm, preferably 0.1 to 0.6 μm. In the case of larger pores with an average pore diameter of 1 μm, the particles of the binder must be porous. The use of porous binder particles prevents the penetration of impurities into the porous particles, and ensures a binding of the particles to one another and to the substrate. In the event that the pores of the porous particles are sufficiently small (i.e. smaller than 1 μm), the binder is assigned an exclusive binding function, i.e. the binding particles do not necessarily have to be porous in such a case. In such a case, the porous particles of the coating material are preferably not completely enveloped by the binder, but rather are only provided with the binder at the contact points between two adjacent porous particles. This guarantees that as many pores of the porous particles as possible remain accessible for air.

The porous particles in accordance with the present invention are preferably thermally and chemically stable, porous oxides, in particular metal oxides, carbides or nitrides. Examples are oxides such as ZnO, CeO₂, SnO₂, Al₂O₃, SiO₂, TiO₂, In₂O₃, ZrO₂, Yttrium-stabilized ZrO₂, Fe₂O₃, Fe₃O₄, Cu₂O or WO₃, but also phosphates, silicates, zirconates, aluminates and stannates, carbides such as WC, CdC₂ or SiC, nitrides such as BN, AlN, Si₃N₄ and Ti₃N₄, corresponding mixed oxides such as metal-tin-oxides, e.g. indium tin oxide (ITO). Furthermore, mixtures of the specified powder particles may also be used. Preferred in particular are Al₂O₃ and SiO₂.

The intermediate spaces between the porous particles are responsible for the penetration and spreading of the fluid residual foodstuffs into the layer. The aim is as effective a distribution/spreading of the impurities into the layer as possible, in order to maximize the engagement area for the thermal degradation. The size distribution of the intermediate spaces is substantially determined by the size of the particles and the volume fraction of the binder.

According to the invention, the volume fraction of the binder in forms of embodiment lies in the range of 5 to 40%, preferably at 20 to 30% or 15 to 25%.

In forms of embodiment, the intermediate spaces between the porous particles are considerably larger than the pores of the porous particles, meaning that impurities can penetrate into the structure and can spread. In this manner, it is always ensured that oxygen for the thermal degradation is in contact with the impurities to be removed, as the pores of the porous particles constantly regenerate, i.e. can absorb air.

The thickness of the coating is at least 50 μm, preferably 100 to 500 μm, particularly preferably 150 to 450 μm, 200 to 40 μm or 250 to 350 μm. Although, greater layer thicknesses are technically able to be realized and are also useful, they are not interesting for economic reasons. If the thickness of the coating, by contrast, is less than 50 μm in embodiments, this does not offer any sufficiently large pore volumes of the pores.

The coating materials according to the invention are stable at high temperatures and resistant to abrasion. The coating materials contain both large pores/pore volumes which are accessible for organic impurities (e.g. fat), and also, via the porous particles, small pores which are not accessible for the organic impurities. The coating materials according to the invention possess a very high suction capacity and transport the organic impurities (e.g. fat or roasting juices) initially into the interior of the coating. There, the impurities are spread out, i.e. distributed over a very large surface area. At a temperature of 250° C., all impurities are almost completely decomposed, and without the layer containing a catalyst. By the targeted adjustment of the binder, and the fact that the binder has precipitated, inorganic particles, a very high interior surface area, preferably greater than 20 m²/g, particularly preferably greater than 70 m²/g and particularly preferably greater than 120 m²/g, is generated, which is loaded with inorganic impurities. On the other hand, the reactant of oxygen which is necessary for combustion is stored in a manner similar to a reservoir in the porous particles, and is immediately available, meaning that the oxidative combustion of the impurities is introduced at an early time and is performed approximately quantitatively at 250° C.

Thus, self-cleaning coatings for baking ovens can be produced which remove organic impurities approximately quantitatively at temperatures considerably below 380° C., preferably below 320° C. In this context, it is not necessary to introduce a catalyst into the layer; the coating according to the invention makes it possible to spread out the organic impurities over a very large area and to provide the reactant necessary for the oxidation in the form of a reservoir in the layer, so that the desired cleaning can take place without catalyst.

The method according to the invention for producing the self-cleaning coating on a part or in a cooking, frying, baking or grilling appliance comprises the application of the coating material according to the invention onto at least one surface area of the part. In this case, the application of the layer may take place by way of all established coating methods.

In one preferred form of embodiment of a coating method, the coating material is applied in the form of a suspension, which is produced by suspending the porous particles and the binder with a suspension medium with the aid of a suspension agent. As a result, a cost-effective, rapid and consistent application of the coating material is made possible. In particular, the application of the suspension of the coating material takes place via spin coating, immersion, flooding or spraying.

In one preferred form of embodiment, the method further contains the step of drying the applied suspension at temperatures of up to 1,200° C., preferably between 200° C. and 1,000° C., particularly preferably between 650° C. and 850° C. Thus, in addition to a simple conduction of the method, good mechanical properties of the coating are possible, such as a good resistance to abrasion, as well as a good level of bonding to the substrate.

The suspension medium is selected, in forms of embodiment, from the group comprising alcohols, preferably 2-butoxyethanol, ethanol, 1-propanol, 2-propanol. As an alternative or in combination with this, water may be used as suspension medium. The suspension medium is preferably water for cost reasons.

In preferred forms of embodiment, the suspension agent is nitric acid or an aqueous solution of nitric acid. By using nitric acid as the suspension agent, the viscosity of the suspension may be set in a suitable manner. Preferably, the viscosity of the suspension is reduced by the use of a suspension agent, so that a more rapid and consistent application of the suspension is possible. In particular when precipitated TiO₂ is used as binder particle, the use of nitric acid as suspension agent makes it possible to produce a coating material or a self-cleaning coating which shows an outstanding level of bonding to the substrate.

The solid content in the suspension lies, in forms of embodiment, between 1 and 20% by weight, preferably between 5 and 15% by weight. Lower levels of solid content delay the speed of the method. Higher levels of solid content are associated with disadvantages with regard to a consistent layer thickness, where applicable.

The invention further relates to a part on or in a cooking, frying, baking or grilling appliance, in particular a baking oven muffle which is produced in accordance with this method. The method is further related to a cooking, frying, baking or grilling appliance, in particular an oven or a stove, which has a corresponding part. Parts of or in cooking, frying, baking or grilling appliances within the meaning of the present invention are not only suspension or insertion parts for ovens and stoves, but also the inner sides of baking oven muffles, i.e. the oven or stove interior (baking compartment) and deep fryers, in principle all metal parts, glass parts or parts with metal or enamel coating of appliances such as ovens, stoves, grills etc., which are directly or indirectly heated during use and which are not in direct contact with the food to be cooked. In accordance with a preferred embodiment of the invention, the parts to be coated involve enameled parts, e.g. enameled steel, i.e. a steel which is provided with an enamel layer with a thickness in the magnitude of 100 μm, which serves to protect against corrosion.

1-15. (canceled)

16. A coating material, suitable for a self-cleaning coating on a part on or in a cooking, frying, baking or grilling appliance for removing residual foodstuffs without mechanical intervention, said coating material comprising:
porous particles; and
a binder connecting the porous particles and having precipitated, inorganic particles.

17. The coating material of claim 16, wherein the precipitated, inorganic particles of the binder are particles which are produced via a precipitation reaction and subsequent grinding.

18. The coating material of claim 16, wherein the grinding of the precipitated, inorganic particles of the binder is implemented by a bead mill or pin mill.

19. The coating material of claim 16, wherein the precipitated, inorganic particles of the binder have an average particle size of >100 nm, preferably from 150 nm to 1,000 nm, more preferably 200 nm to 750 nm, particularly preferably from 250 nm to 500 nm.

20. The coating material of claim 16, wherein the precipitated, inorganic particles of the binder are selected from the group comprising Al₂O₃, SiO₂, TiO₂, ZrO₂ and a mixture thereof.

21. The coating material of claim 16, wherein the precipitated, inorganic particles of the binder are TiO₂.

22. The coating material of claim 16, wherein the binder has a porous structure and is preferably open-pored.

23. The coating material of claim 16, wherein the porous particles and the binder provide the coating material with a porous structure, said porous particles being configured in the absence of a solid or liquid second phase in their pores.

24. A method for producing a self-cleaning coating on a part on or in a cooking, frying, baking or grilling appliance, said method comprising applying onto a surface area of the part a coating material comprised of porous particles and a binder having precipitated, inorganic particles.

25. The method of claim 24, wherein the coating material is applied in the form of a suspension, which is produced by suspending the porous particles and the binder with a suspension medium with the aid of a suspension agent.

26. The method of claim 25, wherein the suspension of the coating material is applied via spin coating, immersion, flooding or spraying.

28. The method of claim 25, further comprising drying the applied suspension at a temperature of up to 1,200° C., preferably between 200° C. and 1,000° C., particularly preferably between 650° C. and 850° C.

29. The method of claim 25, wherein the suspension medium is selected from the group consisting of alcohol, water, and a mixture thereof.

30. The method of claim 29, wherein the alcohol is selected from the group consisting of 2-butoxyethanol, ethanol, 1-propanol, and 2-propanol.

31. The method of claim 25, wherein the suspension agent is nitric acid or an aqueous solution of nitric acid.

32. The method of claim 25, wherein the suspension has a solid content in a range between 1 and 20% by weight, preferably between 5 and 15% by weight.

33. A part on or in a cooking, frying, baking or grilling appliance, in particular a baking oven muffle, said part comprising:
a surface area; and
a coating material applied on the surface area and comprised of porous particles and a binder having precipitated, inorganic particles

34. A cooking, frying, baking or grilling appliance, in particular an oven or stove, comprising a part as set forth in claim 33.
